(19) United States
(12) Patent Application Publication
(10) Pub. No.: US 2020/0004489 A1
(43) Pub. Date: Jan. 2, 2020

(54) ULTRASONIC DISCOVERY PROTOCOL FOR DISPLAY DEVICES

(71) Applicant: Microsoft Technology Licensing, LLC, Redmond, WA (US)

(72) Inventors: Charles Whipple CASE, JR., Lake Oswego, OR (US); Gary LEISKY, Redmond, WA (US)

(73) Assignee: Microsoft Technology Licensing, LLC, Redmond, WA (US)

(21) Appl. No.: 16/024,625

(22) Filed: Jun. 29, 2018

(51) Int. Cl. G06F 3/14; H04B 11/00; H04W 8/00; H04W 76/14; G01S 5/26

(52) U.S. Cl. CPC G06F 3/1446; H04B 11/00; G01S 5/26; H04W 76/14; H04W 8/005

(57) ABSTRACT

A computing system is provided that includes a primary display and a secondary display operatively coupled to a processor and configured to transmit a first signal and a second signal, respectively. The processor is configured to execute an ultrasonic discovery protocol upon detection of a positional trigger event. Execution of the ultrasonic discovery protocol by the processor causes the primary display device to transmit the first signal as an acoustic signal that is received by the secondary display device. In response to receiving the first signal, the secondary display device transmits the second signal to the primary display device. The second signal encodes data that indicates a positional relationship between the primary display device and the secondary display device. Based on the indicated positional relationship, the visual data is cooperatively displayed by the primary and secondary display devices.

### BACKGROUND

Computing systems in communication with multiple display devices allow users to view application programs and digital content across a broader display area. While such setups are a convenient platform for viewing visual data in a larger format, coordinating the display devices to cooperatively display the visual data can be challenging in several ways. Upon initial setup of a computing system that includes more than one display device, the display devices may be randomly oriented, and the computing system may not know the positions and/or orientations of the display devices. When one or more of the display devices is moved, the display of the visual data may become discontinuous or out of sequence. When a new display device is added to the computing system, the computing system may lack information about the position of the new display device, resulting in an inability to include the new display device in the display of visual data. When a user desires to share visual data from one display device to another, multiple nearby display devices may be identified, increasing the risk of inadvertently sharing sensitive data. Such inability of the computing system to recognize the position of each display device and logically display various content of the visual data across the multiple display devices may require frequent updating of the positions of each display device by the user, resulting in interrupted tasks and frustration for the user.

### SUMMARY

To address the above issues, a computing system is described herein that includes a processor, a primary display device, and a secondary display device. The primary display device may be operatively coupled to the processor and configured to transmit a first signal. The secondary display device may be operatively coupled to the processor and configured to transmit a second signal. The processor may be configured to execute an ultrasonic discovery protocol included in a memory. The ultrasonic discovery protocol may be programmatically executed upon detection of a positional trigger event. Execution of the ultrasonic discovery protocol by the processor may cause the primary display device to transmit the first signal. The first signal may be an acoustic signal that is received by the secondary display device via a microphone array. In response to receiving the first signal, the secondary display device may transmit the second signal to the primary display device. The second signal may encode data that indicates a positional relationship between the primary display device and the secondary display device. Based on the indicated positional relationship, the primary and secondary display devices may be configured to cooperatively display the visual data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic diagram of an example computing system according to the present disclosure.

FIG. 2A shows the computing system of FIG. 1 configured with wireless communication between the primary and secondary display devices.

FIG. 2B shows a diagram of the computing system of FIG. 2A during execution of the ultrasonic discovery protocol.

FIG. 3A shows the computing system of FIG. 1 configured with hardwired communication between the primary and secondary display devices.

FIG. 3B shows a diagram of the computing system of FIG. 3A during execution of the ultrasonic discovery protocol.

FIG. 4 shows the computing system of FIG. 1 as the secondary display device is moved in relation to the primary display device.

FIG. 5 shows the computing system of FIG. 1 with the primary display device configured as a mobile computing device.

FIG. 6 shows the computing system of FIG. 1 configured with four display devices.

FIG. 7 shows a grid template defining the positional relationship of the display devices of the computing system of FIG. 6.

FIG. 8 shows a calculation of an orientation of a computing system based on triangulation according to one implementation of the present disclosure.

FIG. 9 shows a flowchart of a method for a computing system, according to one implementation of the present disclosure.

FIG. 10 shows an example computing system according to one implementation of the present disclosure.

### DETAILED DESCRIPTION

The inventors of the subject application have discovered that coordinating multiple display devices to cooperatively display visual data is constrained by the lack of ability of conventional systems to programmatically determine the position of each display device in an array. In a typical configuration of a computing system in communication with multiple display devices, a user manually assigns a position to each display device. For example, in a computing system with three display devices, the user may designate a central display device as a first display device, a display device to the right of the first display device as the second display device, and a display device to the left of the first display device as the third display device. When the orientation of these display devices is changed, the display of visual data may be disrupted or presented in an unintuitive arrangement, requiring the user to intervene to update the positions of the display devices. In some scenarios, the user may desire to share visual data from a first display device to a second display device by “flicking” the visual data to the second display device. The user input of “flicking” may trigger the first display device to ping nearby computing devices, often resulting in a list of several computing devices that requires a selection by the user.

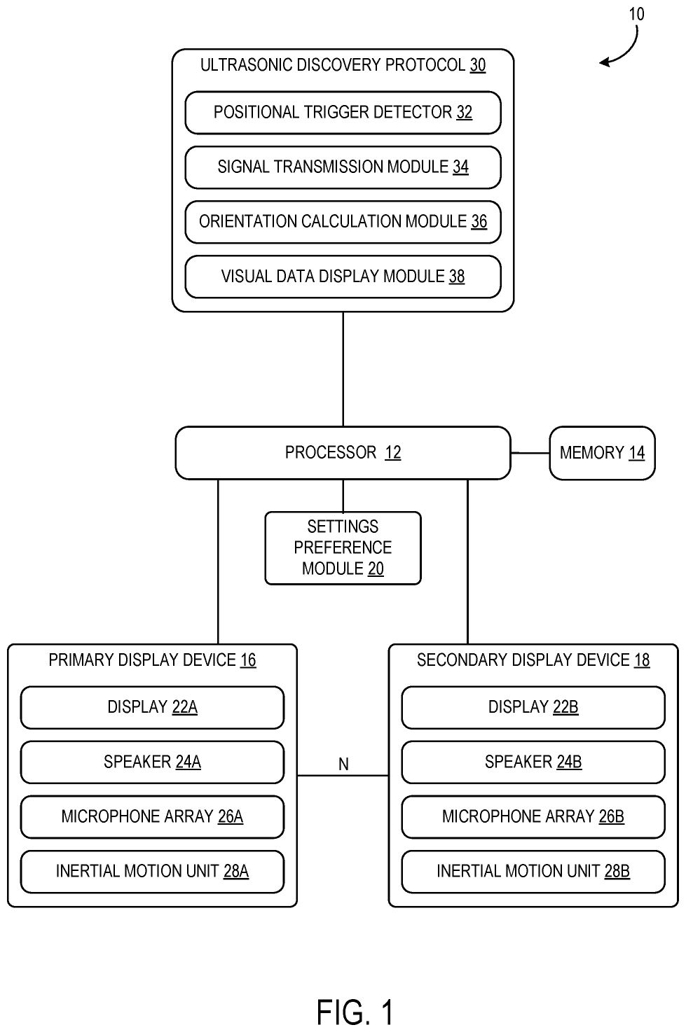

As schematically illustrated in FIG. 1, to address the above identified issues a computing system 10 is provided. The computing system 10 may be capable of displaying visual data VD over a plurality of display devices and may include a processor 12 with associated memory 14, and at least two display devices. The display devices may be configured as a primary display device 16 and a secondary display device 18, and each display device 16, 18 may be operatively coupled to the processor 12. In some implementations, the primary display device 16 may be a master display device that includes the processor 12, and the secondary display device 18 may be a slave device. It will be appreciated that the secondary display device 18 may be configured as a computing device, or as a display monitor without independent functionality as a computing device.

The processor 12 may programmatically designate the primary and secondary display devices 16, 18 based on proximity to the processor 12, for example. However, it will be appreciated that the designation of the display devices as the primary display devices 16 and the secondary display device 18 may alternatively be determined by a user in a settings preference module 20 executed by the processor 12. In addition to being operatively coupled to the processor 12, the primary and secondary display devices 16, 18 may be on a network N with one another as indicated in FIG. 1. As described below, communication across this network N may occur via radio frequencies (e.g. BLUETOOTH), wirelessly via a WIFI technology or the like, or via a wired connection.

As shown in FIG. 1, the primary display device 16 may include a first display 22A, a first speaker 24A, a first microphone array 26A, and a first inertial motion unit (IMU) 28A. As such, the primary display device 16 is configured to transmit and receive acoustic signals. Similarly, the secondary display device 16 may include a second display 22B, a second speaker 24B, a second microphone array 26B, and a second inertial motion unit (IMU) 28B, and is also configured to transmit and receive acoustic signals. When included, the first and second microphone arrays 26A, 26B may be configured as stereoscopic microphone arrays.

To determine the number and orientations of display devices associated with the computing system 10, the processor 12 may be configured to execute an ultrasonic discovery protocol 30 via a program stored in non-volatile memory and executed by a processor of the computing system 10. The ultrasonic discovery protocol 30 may be programmatically executed upon detection of a positional trigger event TE. As discussed in detail below, the positional trigger event TE may be any one of several events, such as powering on of a device, user input, recognition of a new display device in the plurality of display devices, and movement of a display device having an established positional relationship with another display device. The positional trigger event TE may be detected by a positional trigger detector 32 included in the ultrasonic delivery protocol 30.

Execution of the ultrasonic discovery protocol 30 by the processor 12 may activate a signal transmission module 34 included in the ultrasonic discovery protocol 30, and cause the primary display device 16 to transmit a first signal S1. The first signal S1 may be an acoustic signal emitted at an ultrasonic frequency by the first speaker 24A of the primary display device 16. A key property of ultrasonic frequencies, or ultrasound, is that the sound waves are absorbed by soft surfaces and reflected by hard surfaces, such as wall. Thus, it will be appreciated that the first signal S1 may be set to a frequency and emitted at an amplitude that is ineffective for transmitting the first signal S1 through building walls. Specifically, the frequency of the first signal S1 may be at a frequency greater than 20 kHz, and preferably in a range of 20 kHz to 80 kHz. This feature has the beneficial effect of limiting the designation of the secondary display device 18 to display devices within a predetermined range of the first signal S1, thereby avoiding confusion among selectable display devices and decreasing the possibility of unintentionally disclosing sensitive or confidential data.

The first signal S1 may be received via the second microphone array 26B of the secondary display device 18. In response to receiving the first signal S1, the secondary display device 18 may transmit a second signal S2 to the primary display device 16. The second signal S2 may encode data that indicates a positional relationship between the primary display device 16 and the secondary display device 18. As discussed above, the secondary display device 18 may be equipped with the second speaker 24B and thus configured to transmit the second signal S2 acoustically. Additionally or alternatively, the secondary display device 18 may be connected to the primary display device 16 in a hardwired configuration, thereby permitting the second signal S2 to be transmitted electrically or acoustically.

An orientation calculation module 36 included in the ultrasonic discovery protocol 30 may process the data encoded in the second signal S2 that indicates a positional relationship between the primary and secondary display devices 16, 18 to determine the orientation of the secondary display device 16 relative to the position of the primary display device 18. The orientation calculation module 36 may be in communication with the processor 12 and a visual data display module 38 included in the ultrasonic discovery protocol 30. Upon receiving information about the positional relationship between the primary and secondary display devices 16, 18, the visual data display module 38 may provide instructions to the processor 12 to command the primary and secondary display devices 16, 18 to cooperatively display the visual data VD based on the indicated positional relationship of the primary and secondary display devices 16, 18.

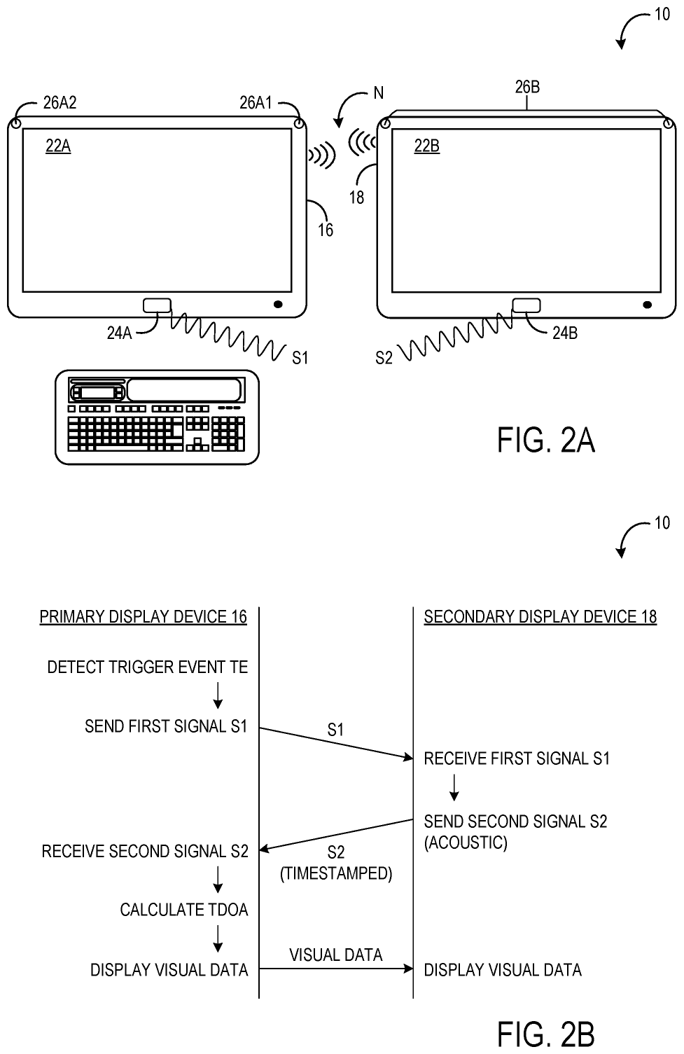

FIGS. 2-6 provide exemplary use-case scenarios for implementations of the ultrasonic discovery protocol 30. As discussed below, communication between the primary display device 16 and other display devices in the array may be configured as wireless, hardwired, or a combination thereof. As discussed above, in any of the described embodiments, it will be appreciated that the first signal S1 is configured to be transmitted to display devices arranged in a room shared with the primary display device 16 that emits the first signal S1, regardless of the mode of communication.

An example use-case scenario of the computing system 10 of FIG. 1 configured with the primary and secondary display devices 16, 18 linked on a wireless network N is illustrated in FIG. 2A. In this scenario, a user may be setting up the computing system 10 for the first time, and the processor 12 may execute the ultrasonic discovery protocol 30 as an out-of-the-box functionality. Additionally or alternatively, as discussed above, the processor 12 may be configured to execute the ultrasonic discovery protocol 30 in response to detection of a positional trigger event TE by the positional trigger detector 32, such as when the primary display device 16, or another display device in communication with the primary display device 16, is powered on, or when a new display in communication with the primary display device 16 is discovered.

When the processor 12 executes the ultrasonic discovery protocol 30, the signal transmission module 34 of the ultrasonic discovery protocol 30 may instruct the primary display device 16 to emit the first signal S1 from the first speaker 24A, as shown in FIG. 2. The first signal S1 may be an ultrasonic acoustic chirp, for example, that is received by the second microphone array 26B of the secondary display device 18. In response to receiving the first signal S1, the secondary display device 18 may transmit the second signal S2. When the primary and secondary display devices 16, 18 are in communication via a wireless network N, the second signal S2 may be an acoustic signal emitted by the second speaker 24B of the secondary display device 18, as shown in FIG. 2, and received by the first microphone array 26A of the primary display device 16. The second signal S2 may include an acoustic chirp that is modulated to encode bits of data. The data may indicate a distance or location of the secondary display device 18 in relation to the primary display device 16, for example. The second signal S2 may further include a timestamp to indicate the time of emission from the second speaker 24B. As discussed above, either or both of the first and second microphone arrays 26A, 26B may be stereoscopic microphone arrays. As such, the second signal S2 may arrive at a near microphone 26A1 in the first stereoscopic microphone array 26A at a first time of arrival TOA1, and the second signal S2 may arrive at a far microphone 26A2 of the first stereoscopic microphone array 26A at a second time of arrival TOA2. With each microphone in the first microphone array 26A receiving the timestamped second signal S2 at a unique TOA, the orientation calculation module 36 of the ultrasonic discovery protocol 30 may perform acoustic source localization on the second signal S2 by applying a cross-correlation function that calculates a time difference of arrival (TDOA) between the first and second times of arrival TOA1, TOA2.

Additionally, while the first and second microphone arrays 26A, 26B may be conventionally enabled to measure sound pressure, each microphone included in the first and second microphone arrays 26A, 26B may be additionally equipped with a polar pattern to further distinguish a direction of a received acoustic signal. The resulting data may determine a direction of the secondary display device 18 in relation to the primary display device 16. With this data and the TDOA between the microphones in the first stereoscopic microphone array 26A, the orientation calculation module 36 of the ultrasonic discovery protocol 30 can determine the position and orientation of the secondary display device 18, thereby enabling the visual data display module 38 to coordinate the display of visual data VD across the primary and secondary display devices 16, 18.

In some scenarios, ambient noise or other ultrasonic signals may result in the inability of the computing system 10 to distinguish the first and/or second signal S1, S2. In such cases, the signal transmission module 34 of the ultrasonic discovery protocol 30 may be configured to instruct the primary and/or secondary display device 16, 18 to emit the first and/or second signal S1, S2, respectively, at an alternative ultrasonic frequency or rate of occurrence to overcome any ambiguities in the identification of the orientation of either the primary or secondary display devices 16, 18.

FIG. 2B shows an exemplary communication exchange between the primary and secondary display devices 16, 18 of the computing system 10 linked on a wireless network N during execution of the ultrasonic discovery protocol 30. While the processor 12 is included in the primary display device 16 in this example for the sake of simplicity, it will be appreciated that the processor 12 may be arranged independently of the primary display device 16. As shown, the detection of a positional trigger event TE results in the programmatic execution of the ultrasonic discovery protocol 30, which commences with commanding the primary display device 16 to send the first signal S1. As discussed above, the first signal S1 may be an ultrasonic acoustic signal such as a chirp. Upon receiving the first signal S1, the secondary display device 18 is commanded to transmit the second signal S2. When the primary and secondary display devices 16, 18 are in communication via a wireless network N, the second signal S2 may be transmitted as an acoustic signal configured as a chirp modulated to include bits of data indicating a distance or location of the secondary display device 18. The second signal S2 may further include a timestamp. As described above, the primary display device 16 may be equipped with a stereoscopic microphone array 26A such that the second signal S2 is received at each microphone in the microphone array 26A at a unique TOA. When the second signal S2 is received at the primary display device 16, the orientation calculation module 36 may determine the positional relationship between the primary and secondary display devices 16, 18 with reference to data included in the chirp and the TDOA, as described above, and the primary and secondary display devices 16, 18 may be directed to cooperatively display visual data VD based on the positional relationship.

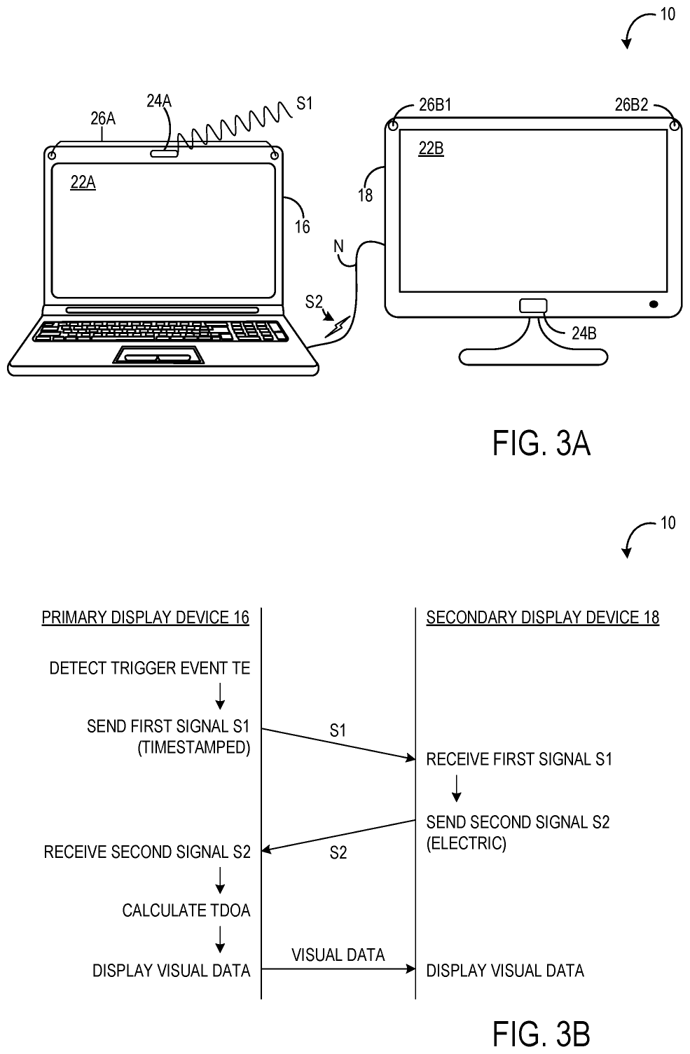

An example use-case scenario of the computing system 10 of FIG. 1 configured with the primary and secondary display devices 16, 18 linked on a network N via a wired connection is illustrated in FIG. 3. Similarly to the implementation discussed above with reference to FIG. 2, execution of the ultrasonic discovery protocol 30 by the processor 12 may cause the signal transmission module 34 of the ultrasonic discovery protocol 30 to instruct the primary display device 16 to transmit the first signal S1 as an ultrasonic acoustic chirp emitted from the first speaker 24A. The first signal S1 may be received by the second microphone array 26B of the secondary display device 18 and may include a timestamp to indicate the time of emission from the first speaker 24A. As discussed above, either or both of the first and second microphone arrays 26A, 26B may be stereoscopic microphone arrays, including microphones conventionally equipped to measure sound pressure, and additionally including independent polar patterns to cooperatively distinguish a direction of a received acoustic signal. When the second microphone array 26B is configured as such, TOAs for the first signal S1 can be determined for each microphone included in the second microphone array 26B of the secondary display device 18. For example, the first signal S1 may arrive at a near microphone 26B1 in the second stereoscopic microphone array 26B at a first time of arrival TOA1, and the first signal S1 may arrive at a far microphone 26B2 of the second stereoscopic microphone array 26B at a second time of arrival TOA2. As described above, the orientation calculation module 36 of the ultrasonic discovery protocol 30 may perform acoustic source localization on the first signal S1, using the timestamp and differences in the TDOA for each microphone included in the second microphone array 26B to calculate the distance and direction of the primary display device 16 in relation to the secondary display device 18.

In response to receiving the first signal S1, the secondary display device 18 may transmit the second signal S2. When the primary and secondary display devices 16, 18 are in hardwired communication on the network N, the second signal S2 may be an electric signal transmitted by the secondary display device 18, as shown in FIG. 2. The second signal S2 may include data describing the positional relationship between the primary and secondary display devices 16, 18 that permits the visual data display module 38 to coordinate the display of visual data VD across the primary and secondary display devices 16, 18 based on the indicated positional relationship.

FIG. 3B shows an exemplary communication exchange between the primary and secondary display devices 16, 18 of the computing system 10 configured with hardwired communication during execution of the ultrasonic discovery protocol 30. While the processor 12 is included in the primary display device 16 in this example for the sake of simplicity, it will be appreciated that the processor 12 may be arranged independently of the primary display device 16. Similar to the example shown in FIG. 2B, the detection of a positional trigger event TE results in the programmatic execution of the ultrasonic discovery protocol 30, which commences with commanding the primary display device 16 to send the first signal S1. As discussed above, the first signal S1 may be an ultrasonic acoustic signal such as a chirp, and the first signal may additionally be configured to include a timestamp. Upon receiving the first signal S1, the secondary display device 18 is commanded to transmit the second signal S2. As described above, the secondary display device 18 may be equipped with a stereoscopic microphone array 26B such that the first signal S1 is received at each microphone in the microphone array 26B at a unique TOA. In the case of the primary and secondary display devices 16, 18 in communication via a hardwired network N, the second signal S2 may be transmitted as an electric signal encoding data that indicates the TOA of the first signal S1 at each microphone included in the second microphone array 26B. When the second signal S2 is received at the primary display device 16, the orientation calculation module 36 may determine the positional relationship between the primary and secondary display devices 16, 18 with reference to the TDOA as described above, and the primary and secondary display devices 16, 18 may be directed to cooperatively display visual data VD based on the positional relationship.

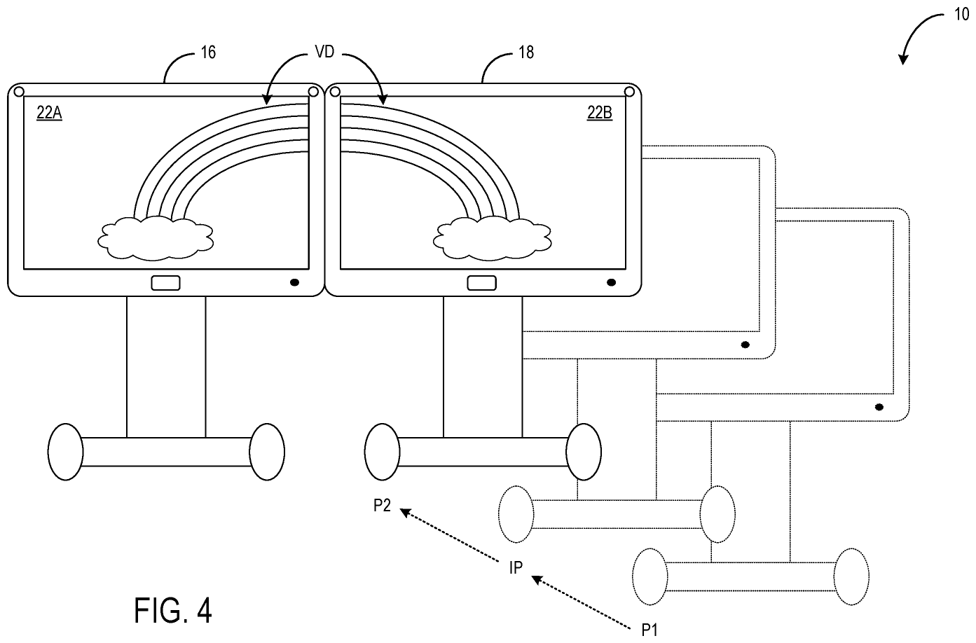

In addition to the trigger events TE described above, the processor 12 may be configured to execute the ultrasonic discovery protocol 30 when movement is detected in at least one of the display devices in the array. FIG. 4 shows an example of this use-case scenario, with the computing system of FIG. 1 including primary and secondary display devices 16, 18 configured as display devices mounted on rolling supports.

As discussed above in reference to FIG. 1, the primary and secondary display devices 16, 18 may include first and second IMUs 28A, 28B in addition to the first and second microphone arrays 26A, 26B. When included, the first and second IMUs 28A, 28B may each be configured to measure a magnitude and a direction of acceleration in relation to standard gravity to sense an orientation of the primary and secondary display devices 16, 18, respectively. Accordingly, the first and second IMUs 28A, 28B may include accelerometers, gyroscopes, and possibly magnometers configured to measure the positions of the display devices 16, 18, respectively, in six degrees of freedom, namely x, y, z, pitch, roll and yaw, as well as accelerations and rotational velocities, so as to track the rotational and translational motions of the display devices 16, 18, respectively. As such, the movement of one or both of the primary and secondary display devices 16, 18 may be detected by one or more of the IMUs 28A, 28B, the microphone arrays 26A, 26B, and a change in TOA of the transmitted signals S1, S2.

When detected, the movement of the primary or secondary display devices 16, 18 may cause an increase in the frequency of execution of the ultrasonic discovery protocol 30. As discussed above, the processor 12 may be configured to programmatically execute the ultrasonic discovery protocol 30 in response to the detection of one of the described positional trigger events TE. Typically, the ultrasonic discovery protocol 30 may be executed periodically to determine the positional relationship between the primary and secondary display devices 16, 18 and detect any changes. However, when the positional trigger event TE is movement of one of the primary or secondary display devices 16, 18, the processor 12 may be configured to execute the ultrasonic discovery protocol 30 repeatedly until it is determined that the display device in motion has come to rest.

For example, as shown in FIG. 4, the primary and secondary display devices 16, 18 of the computing system 10 may be in a configuration of cooperatively displaying visual data VD when the secondary display device 18 moves from a first position P1 to a second position P2, and the transition may include at least one intermediate position IP. The second IMU 28B included in the secondary display device 18 may detect motion of the secondary display device 18 as it leaves the first position P1. The movement may serve as the positional trigger event TE that is detected by the positional trigger detector 32, thereby causing the processor 12 to execute the ultrasonic discovery protocol 30. As the primary and secondary display devices 16, 18 exchange signals S1, S2 as described above with reference to FIGS. 2 and 3, the orientation calculation module 36 may determine that the current position of the secondary display device 18 is different than the first position P1. For example, the secondary display device 18 may be in the intermediate position IP. However, as the second IMU 28B continues to detect movement of the secondary display device 18, the processor 12 may be directed to repeat the execution of the ultrasonic discovery protocol 30. Upon another exchange of signals S1, S2 between the primary and secondary display devices 16, 18, the orientation calculation module 36 may determine that the current position of the secondary display device 18 is at the second position P2. The execution of the signal transmission and orientation calculation modules 34, 36 of the ultrasonic discovery protocol 30 may be repeated to continue transmitting the first and second signals S1, S2 and calculating the position of the secondary display device 18 relative to the first display device 16 until no further movement is detected for the secondary display device 18. When it is determined that the secondary display device 18 is at rest, the positional relationship between the primary and secondary display devices 16, 18 may be updated, and the visual data display module 38 may coordinate the display of visual data VD across the primary and secondary display devices 16, 18 based on the new positional relationship.

While the example illustrated in FIG. 4 depicts movement of the secondary display device 18 toward the primary display device 16, it will be appreciated that the ultrasonic discovery protocol 30 may be executed when any change in the position of the primary and/or secondary display devices 16, 18 is detected, including a shift in the angle of the first and/or second displays 22A, 22B. Additionally or alternatively, the ultrasonic discovery protocol 30 may be configured to uncouple the secondary display device 18 from the primary display device 16 and cease displaying the visual data VD if it is determined that the secondary display device 18 has moved beyond a predetermined threshold distance from the primary display device 16. The predetermined distance may be between 10 centimeters in one embodiment, or an alternative value between 10 and 100 centimeters. Other values are also possible, depending on the application. It will be appreciated that larger displays may call for larger threshold values, and smaller displays may call for smaller threshold values.

In any of the embodiments described herein, a display mode for displaying the visual data VD may be defined on the basis of the positional relationship of the primary and secondary display devices 16, 18. In some implementations, the primary and secondary display devices 16, 18 may be configured to display the visual data VD as a single image across the first and second displays 22A, 22B, as shown in FIG. 4. This configuration may be realized when the positional relationship between the primary and secondary display devices 16, 18 is determined to be a side-by-side orientation, for example, thereby prompting execution of an ad hoc “join display” command.

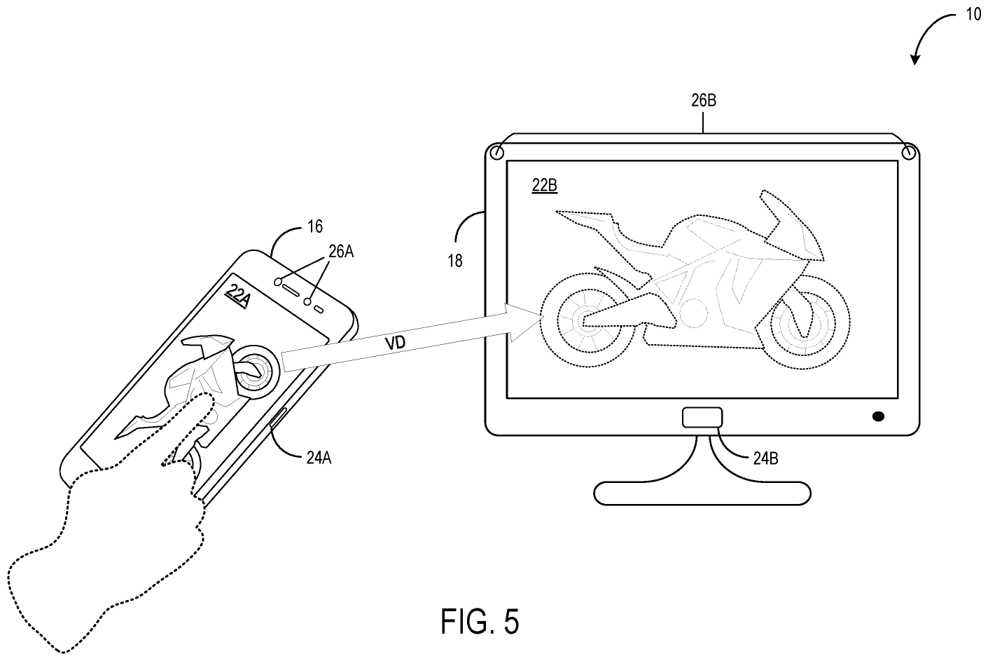

In some implementations, it may be desirable to transfer visual data VD from the primary display device 16 to the secondary display device 18. For example, as shown in FIG. 5, the primary display device 16 may be configured as a mobile computing device with a touch-sensitive first display 22A, and the user may desire to transfer the visual data VD to the larger second display 22B of the secondary display device 18. In this use-case scenario, the user may make a flicking or swiping motion on the first display 22A that is recognized by the positional trigger detector 32 as a user input positional trigger event TE.

Upon recognition of the positional trigger event TE, the processor 12 may execute the ultrasonic discovery protocol 30. As the primary display device 16 emits the first signal S1, the ultrasonic discovery protocol 30 may be configured to identify a display device in closest proximity to the primary display device 16 as the secondary display device 18. As described above with reference to FIGS. 2 and 3, the signal transmission module may instruct the primary and secondary display devices 16, 18 to transmit the first and second signals, respectively, and the orientation calculation module 36 may determine the position of the secondary display device 18 relative to the position of the primary display device 16 such that the visual display module 38 may coordinate the transfer of visual data VD from the primary display device 16 to the secondary display device 18.

While the implementation described with reference to FIG. 5 is particularly well-suited to use-case scenarios in which the primary display device 16 is configured as a mobile computing device such as a mobile telephone or a tablet, it will be appreciated that the ultrasonic discovery protocol 30 may be configured to identify any display device in closest proximity to the primary display device 16 as the secondary display device 18. As described above, frequencies associated with the ultrasonic discovery protocol 30 are ineffective as transmitting signals through building walls. This feature has the effects of avoiding confusion in the selection of the secondary display device 18, and of limiting the risk of inadvertently sharing potentially sensitive information with other nearby display devices, especially when executed in a room with a closed door. Additionally, in any of the embodiments described herein, the ultrasonic discovery protocol 30 may be configured to require the user to confirm the identity of the secondary display device 18 prior to executing the visual data display module 38 to cooperatively display the visual data VD across the primary and secondary display devices 16, 18.

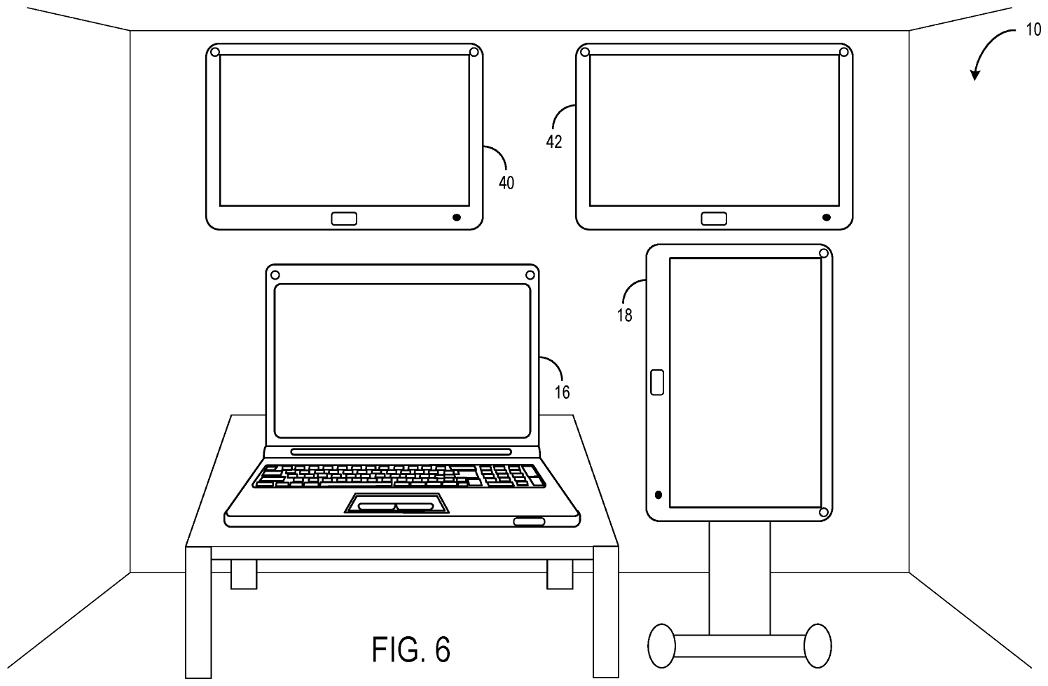

While the computing system 10 described above includes the primary display device 16 and the secondary display device 18, it will be appreciated that the plurality of display devices included in the computing system 10 is not limited to any particular quantity. In any of the implementations described herein, the computing device 10 may be configured to include one or more displays in addition to the primary display device 16 and the secondary display device 18. For example, as shown in FIG. 6, the computing system 10 may further include a third display device 40 and a fourth display device 42. To permit determination of an orientation relative to the primary display device 16 during execution of the ultrasonic discovery protocol 30, the third display device 40 may be configured to transmit a third signal S3 that is transmitted to the primary display device 16. Similarly, the fourth display device 42 may be configured to transmit a fourth signal S4 that is transmitted to the primary display device 16.

Additionally or alternatively, when the secondary display device 16 is configured as a slave device, the primary display device 18 may utilize components of the slaved secondary device, such as transducers and/or microphone arrays, to determine the relative positions of other display devices associated with the computing system 10. This configuration may supplement information generated by the primary display device 16 to increase accuracy (i.e., a supplemental point-of-view), or provide positional information for display devices that are not directly detectable by the primary display device 16 during execution of the ultrasonic discovery protocol 30.

In the example use-case scenario shown in FIG. 6, a display in front of a keyboard may be configured as the primary display device 16, and the display situated to the right, from the perspective of the user facing the primary display device 16, may be configured as the secondary display device 18. The third and fourth display devices included in the computing system 10 may be configured as tertiary and quaternary display devices 40, 42, respectively, and arranged above and to the right of the primary display device 16. the processor 12 may be configured to transmit the positional relationship of display devices in the plurality of display devices to each display device included in the computing system 10.

In the example illustrated in FIG. 6, the primary display device 16 is configured as a mobile computing device, the secondary display 18 is configured as a display device mounted on a rolling support, and the third and fourth display devices 40, 42 are configured as monitors mounted on a wall. However, it will be appreciated that the display devices 16, 18, 40, 42 of the computing system 10 are not limited to the illustrated configurations. Rather, the illustrated configurations are provided to demonstrate that each display device included in the computing system 10 may be configured as any one of a variety of display device configurations, including desktop computing devices, laptop computing devices, mobile telephones, tablets, mobile monitors, and fixed monitors.

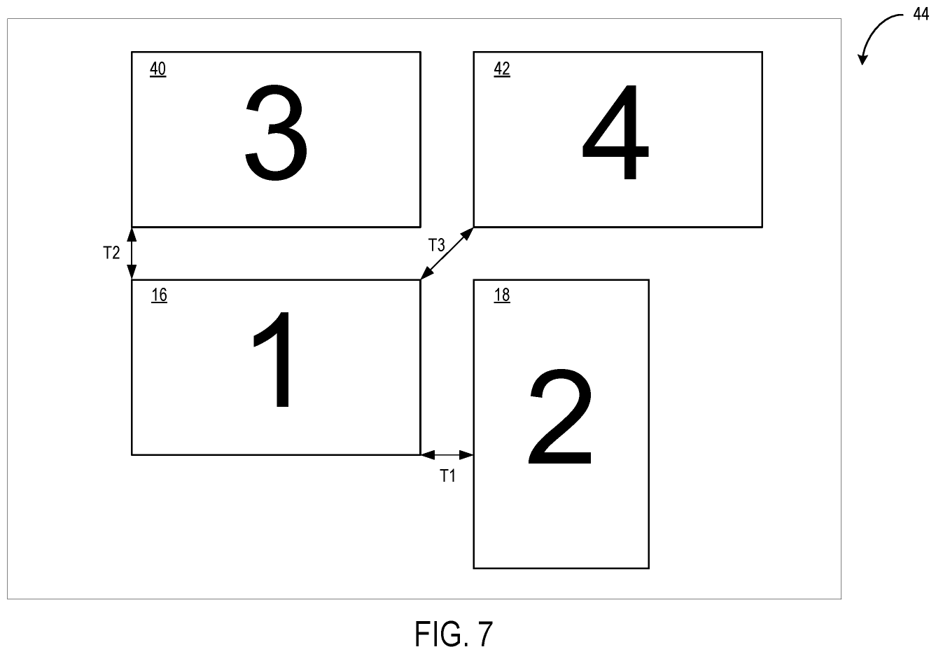

The positional relationship of the primary and secondary display devices 16, 18, as well as any other display devices included in the computing system 10, may be defined by a grid template 44, as shown in FIG. 7. The grid template 44 may be viewable by the user and indicate the configuration of each display device included in the computing system 10. In some implementations, the arrangement of the display devices and their designations as the primary, secondary, tertiary, and quaternary display devices 16, 18, 40, and 42 may be determined by the ultrasonic discovery protocol 30 and reconfigured by the user. Additionally or alternatively, the designation of the primary display device 16 may be determined by user designation or by determination of a cooperative arbitration algorithm. The designations of the display devices may be prioritized based on a device class, performance capability, environmental considerations, or the like, for example. While the example illustrated in FIG. 7 indicated four display devices oriented to face the same direction, it will be appreciated that display devices may be oriented to face in separate directions. A facing direction of a non-forward-facing display device may be shown in the grid template 44 by using a shape that provides depth perception to indicate a departure from a forward planar orientation, such as a trapezoid, for example.

Further, in any of the implementations described herein, a display device may be required to be within a predetermined threshold distance T of other display devices in the array. When a display device enters the limitation of the threshold distance T, it may be joined into the array of display devices. As described above, the recognition of a new display device in the plurality of display devices is a positional trigger event TE that causes the execution of the ultrasonic discovery protocol 30 to determine the position of the display device. Also as described above, the movement of a display device having an established positional relationship with another display device is a positional trigger event TE that causes the execution of the ultrasonic discovery protocol 30 to determine the position of the display device. When the display device moves outside of the predetermined threshold distance T of the array, the display device may be disconnected from the array.

The threshold distance T may be configured according to direction. For example, as shown in FIG. 7, a threshold distance T1 may be determined for a horizontal distance between display devices. Similarly, threshold distances T2 and T3 may be determined for vertical or diagonal distances between display devices, respectively. Any of the predetermined threshold distances T may be default measurements included in the ultrasonic discovery protocol 30, and/or they may set by a user.

In any of the above embodiments, it will be appreciated that the relative orientation of the displays may be taken into account in addition to the relative position, such that displays positioned proximate to each other, but facing in opposite or nearly opposite directions (thus not being visible from a same vantage point), are not paired together in a display array for cooperative display according to a pairing logic of the computing system 10. The orientation of each display may be detected by mounting ultrasonic emitters on each side (i.e., front and back) of a display to create a three-dimensional microphone array, and detecting the relative difference in sound received from a front-mounted emitter and a rear mounted emitter.

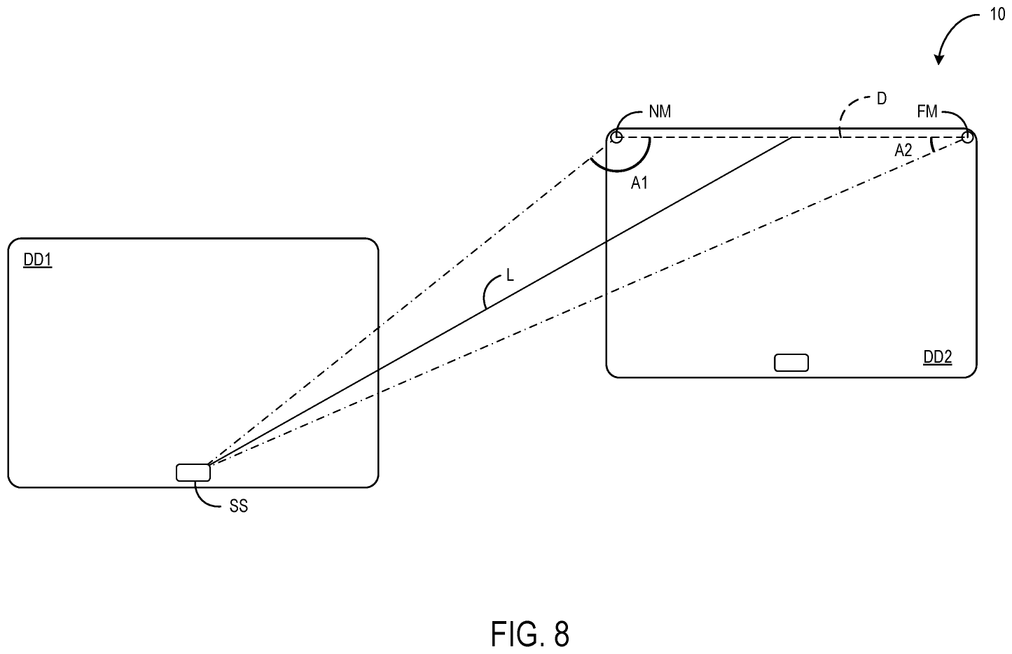

Additionally, as shown in FIG. 8, a relative orientation of the displays included in the computing system 10 may be calculated by triangulation. In a configuration in which sound is emitted from a sound source SS, a location L of the sound source SS may be calculated by measuring angles to the sound source SS from two known locations at which the sound is received. In the illustrated example shown in FIG. 8, the sound source SS may be a speaker included in a first display device DD1, and received at a stereoscopic microphone array of a second display device DD2, depicted in FIG. 8 as a near microphone NM and a far microphone FM. With a known distance D between the near and far microphones NM, FM, an angle A1 at which the sound is received at the near microphone NM, and an angle A2 at which the sound is received at the far microphone FM, the location L of the sound source SS can be determined by applying the equation:

$$L = \frac{D ( sin A 1 ) ( sin A 2 )}{sin ( A 1 + A 2 )} .$$

A direction angle DA of the sound source SS may be measured with a stereoscopic microphone array by computing a time delay T at which the sound is received at the far microphone FM after the sound is received at the near microphone NM, in combination with the known speed of the sound V and the distance D between the near and far microphones NM, FM by applying the equation:

DA=arcsin(TV/D)

Additionally or alternatively, more than two microphones may be included in the array, such as the three-dimensional microphone array described above, and the location L of the sound source SS may be determined by triangulation to calculate vectors in three dimensions. The evaluation of multiple angles may maximize the accuracy of determining the location L of the sound source SS. Algorithms including criteria such as strength of the sound signal, spatial probability, and know locations of included components may be applied to estimate a confidence level of the location L of the sound source. If the confidence level is below a predetermined threshold, execution of the ultrasonic discovery protocol 30 may be repeated.

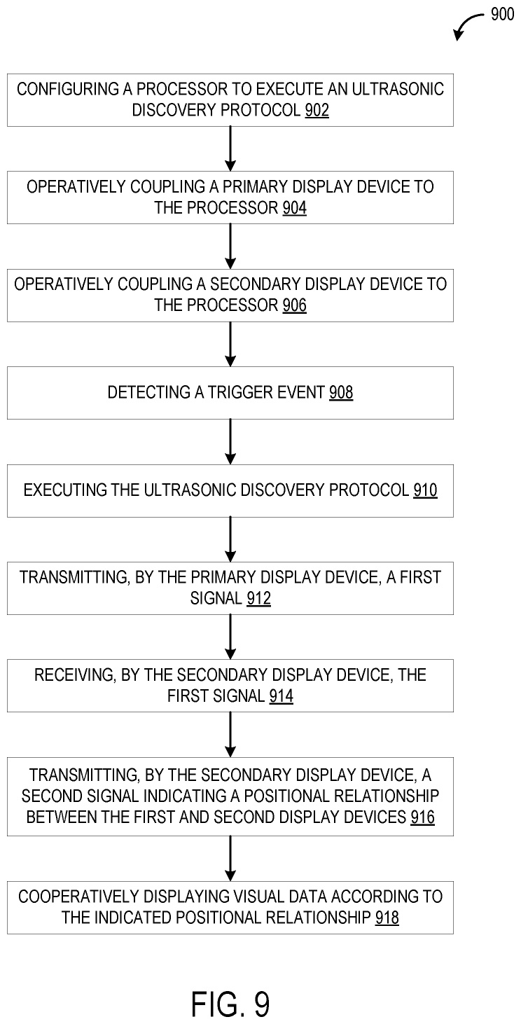

FIG. 9 shows a flow chart for an example method according to an embodiment of the present description. Method 900 may be implemented on any implementation of the computing system 10 described above or on other suitable computer hardware. The computing system 10 may be capable of displaying visual data VD over a plurality of display devices and may include a processor 12 with associated memory 14, and at least two display devices.

At step 902, the method 900 may include configuring the processor to execute an ultrasonic discovery protocol included in the associated memory. As described above, the ultrasonic discovery protocol may determine a positional relationship between display devices included in the computing system 10 such that visual data may be cooperatively displayed across the display devices.

Advancing to step 904, the method 900 may include operatively coupling a primary display device to the processor, the primary display device being configured to transmit a first signal. Continuing from step 904 to step 906, the method 900 may include operatively coupling a secondary display device to the processor, the secondary display device being configured to transmit a second signal. In addition to being operatively coupled to the processor, the primary and secondary display devices may be in communication with one another. In some implementations, this communication may occur wirelessly, via BLUETOOTH technology or the like. Additionally or alternatively, the primary display device may be connected to the secondary display device via a wired connection.

Proceeding from step 906 to step 908, the method 900 may further include detecting a positional trigger event. As described above, the positional trigger event may be any one of several events, such as powering on of a device, user input, recognition of a new display device in the plurality of display devices, and movement of a display device having an established positional relationship with another display device. The positional trigger event TE may be detected by a positional trigger detector included in the ultrasonic discovery protocol.

Advancing from step 908 to step 910, the method 900 may include executing the ultrasonic discovery protocol. As described above, execution of the ultrasonic discovery protocol by the processor may activate a signal transmission module included in the ultrasonic discovery protocol, and cause the primary display device to transmit a first signal. Accordingly, continuing from step 910 to step 912, the method 900 may include transmitting, by the primary display device. The first signal may be an acoustic signal emitted by the first speaker of the primary display device 16.

Proceeding from step 912 to step 914, the method 900 may further include receiving, by a microphone array of the secondary display device, the first signal. In response to receiving the first signal, at step 916 the method 900 may include transmitting, by the secondary display device to the primary display device, the second signal. As described above, the second signal may encode data that indicates a positional relationship between the primary display device and the secondary display device. As discussed above, the secondary display device may be equipped with the second speaker and thus configured to transmit the second signal acoustically. Additionally or alternatively, the method may further include connecting the primary display device to the secondary display device via a wired connection such that the second signal can be transmitted electrically or acoustically.

Advancing from step 916 to step 918, the method 900 may include cooperatively displaying the visual data on the primary and secondary display devices based on the indicated positional relationship. As described above, an orientation calculation module included in the ultrasonic discovery protocol may process the data encoded in the second signal that indicates a positional relationship between the primary and secondary display devices to determine the orientation of the secondary display device relative to the position of the primary display device. The orientation calculation module may be in communication with the processor and a visual data display module included in the ultrasonic discovery protocol. Upon receiving information about the positional relationship between the primary and secondary display devices the visual data display module may provide instructions to the processor to command the primary and secondary display devices to cooperatively display the visual data VD based on the indicated positional relationship of the primary and secondary display devices. As described above, the method may further include defining a display mode for displaying the visual data based on the positional relationship of the primary and secondary display devices, and the positional relationship may be defined by a grid template.

In some embodiments, the methods and processes described herein may be tied to a computing system of one or more computing devices. In particular, such methods and processes may be implemented as a computer-application program or service, an application-programming interface (API), a library, and/or other computer-program product.

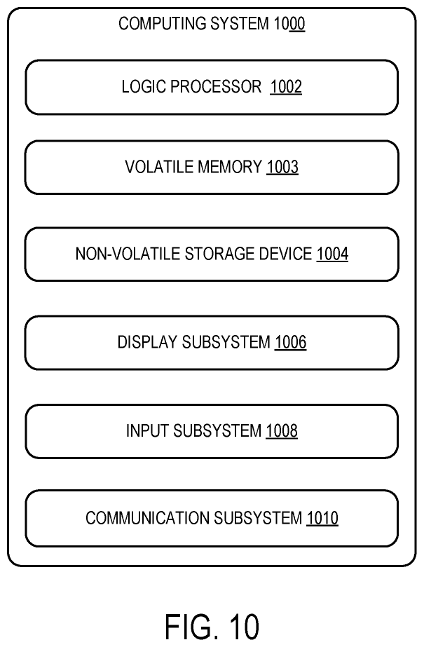

FIG. 10 schematically shows a non-limiting embodiment of a computing system 1000 that can enact one or more of the methods and processes described above. Computing system 1000 is shown in simplified form. Computing system 1000 may embody the computing system 10 of FIG. 1. Computing system 1000 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 1000 includes a logic processor 1002 volatile memory 1003, and a non-volatile storage device 1004. Computing system 1000 may optionally include a display subsystem 1006, input subsystem 1008, communication subsystem 1010, and/or other components not shown in FIG. 10.

Logic processor 1002 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1002 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1004 includes one or more physical devices configured to hold instructions executable by the logic processors to implement the methods and processes described herein. When such methods and processes are implemented, the state of non-volatile storage device 1004 may be transformed—e.g., to hold different data.

Non-volatile storage device 1004 may include physical devices that are removable and/or built-in. Non-volatile storage device 1004 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1004 may include nonvolatile, dynamic, static, read/write, read-only, sequential-access, location-addressable, file-addressable, and/or content-addressable devices. It will be appreciated that non-volatile storage device 1004 is configured to hold instructions even when power is cut to the non-volatile storage device 1004.

Volatile memory 1003 may include physical devices that include random access memory. Volatile memory 1003 is typically utilized by logic processor 1002 to temporarily store information during processing of software instructions. It will be appreciated that volatile memory 1003 typically does not continue to store instructions when power is cut to the volatile memory 1003.

Aspects of logic processor 1002, volatile memory 1003, and non-volatile storage device 1004 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 typically implemented in software by a processor to perform a particular function using portions of volatile memory, which function involves transformative processing that specially configures the processor to perform the function. Thus, a module, program, or engine may be instantiated via logic processor 1002 executing instructions held by non-volatile storage device 1004, using portions of volatile memory 1003. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1006 may be used to present a visual representation of data held by non-volatile storage device 1004. The visual representation may take the form of a graphical user interface (GUI). As the herein described methods and processes change the data held by the non-volatile storage device, and thus transform the state of the non-volatile storage device, the state of display subsystem 1006 may likewise be transformed to visually represent changes in the underlying data. Display subsystem 1006 may include one or more display devices utilizing virtually any type of technology. Such display devices may be combined with logic processor 1002, volatile memory 1003, and/or non-volatile storage device 1004 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1010 may be configured to communicatively couple various computing devices described herein with each other, and with other devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 1000 to send and/or receive messages to and/or from other devices via a network such as the Internet.

The following paragraphs provide additional support for the claims of the subject application. One aspect provides a computing system capable of displaying visual data over a plurality of display devices. The computing system may comprise a processor, a primary display device, and a secondary display device. The processor may be configured to execute an ultrasonic discovery protocol. The primary display device may be operatively coupled to the processor and configured to transmit a first signal. The secondary display device may be operatively coupled to the processor and configured to transmit a second signal. The ultrasonic discovery protocol may be programmatically executed upon detection of a positional trigger event. Execution of the ultrasonic discovery protocol by the processor may cause the primary display device to transmit the first signal. The first signal may be an acoustic signal received via a microphone array of the secondary display device. In response to receiving the first signal, the secondary display device may transmit the second signal to the primary display device. The second signal may encode data that indicates a positional relationship between the primary display device and the secondary display device. Based on the indicated positional relationship, the primary and secondary display devices may be configured to cooperatively display the visual data.

In this aspect, additionally or alternatively, the positional trigger event may be one of powering on of a device, user input, recognition of a new display device in the plurality of display devices, and movement of a display device having an established positional relationship with another display device. In this aspect, additionally or alternatively, the movement of a display device may be detected by one of an inertial motion unit, a microphone array, and a change in time of arrival of a transmitted signal. In this aspect, additionally or alternatively, the movement of a display device causes an increase in the frequency of execution of the ultrasonic discovery protocol.

In this aspect, additionally or alternatively, the primary display device may include a speaker and a microphone array. In this aspect, additionally or alternatively, the microphone array of the second device may be a stereoscopic microphone array. In this aspect, additionally or alternatively, the second signal may be transmitted electrically or acoustically.

In this aspect, additionally or alternatively, the primary display device may be a master display device including the processor, and the secondary display device may be a slave device. In this aspect, additionally or alternatively, the computing system may further comprise a third display device configured to transmit a third signal, and a fourth display device configured to transmit a fourth signal. In this aspect, additionally or alternatively, the positional relationship of the primary and secondary display devices may be defined by a grid template. In this aspect, additionally or alternatively, the ultrasonic discovery protocol may be configured to identify a display device in closest proximity to the primary display device as the secondary display device. In this aspect, additionally or alternatively, the primary display device may be connected to the secondary display device via a wired connection.

In this aspect, additionally or alternatively, a display mode for displaying the visual data may be defined on a basis of the positional relationship of the primary and secondary display devices. In this aspect, additionally or alternatively, the processor may be configured to transmit the positional relationship of display devices in the plurality of display devices to each display device. In this aspect, additionally or alternatively, the first signal may be set to a frequency and emitted at an amplitude that is ineffective for transmitting the first signal through building walls.

Another aspect provides a method for displaying visual data over a plurality of display devices. The method may comprise configuring a processor to execute an ultrasonic discovery protocol and operatively coupling a primary display device and a secondary display device to the processor, the primary display device being configured to transmit a first signal and the secondary display device being configured to transmit a second signal. The method may further include detecting a positional trigger event, executing the ultrasonic discovery protocol, and transmitting, by the primary display device, the first signal, the first signal being an acoustic signal. The method may further include receiving, by a microphone array of the secondary display device, the first signal, and in response to receiving the first signal, transmitting, by the secondary display device to the primary display device, the second signal, the second signal encoding data that indicates a positional relationship between the primary display device and the secondary display device. The method may further include cooperatively displaying the visual data on the primary and secondary display devices based on the indicated positional relationship.

In this aspect, additionally or alternatively, the method may further comprise defining a display mode for displaying the visual data based on the positional relationship of the primary and secondary display devices. In this aspect, additionally or alternatively, method may further comprise defining the positional relationship of the primary and secondary display devices by a grid template. In this aspect, additionally or alternatively, the method may further comprise connecting the primary display device to the secondary display device via a wired connection such that the second signal can be transmitted electrically or acoustically.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system capable of displaying visual data over a plurality of display devices, the computing system comprising:
a processor configured to execute an ultrasonic discovery protocol;
a primary display device operatively coupled to the processor and configured to transmit a first signal; and
a secondary display device operatively coupled to the processor and configured to transmit a second signal, wherein
the ultrasonic discovery protocol is programmatically executed upon detection of a positional trigger event;
execution of the ultrasonic discovery protocol by the processor causes the primary display device to transmit the first signal, the first signal being an acoustic signal received via a microphone array of the secondary display device;
in response to receiving the first signal, the secondary display device transmits the second signal to the primary display device, the second signal encoding data that indicates a positional relationship between the primary display device and the secondary display device; and
the primary and secondary display devices are configured to cooperatively display the visual data based on the indicated positional relationship.

2. The computing system according to claim 1, wherein the positional trigger event is one of powering on of a device, user input, recognition of a new display device in the plurality of display devices, and movement of a display device having an established positional relationship with another display device.

3. The computing system according to claim 2, wherein the movement of a display device is detected by one of an inertial motion unit, a microphone array, and a change in time of arrival of a transmitted signal.

4. The computing system according to claim 2, wherein the movement of a display device causes an increase in the frequency of execution of the ultrasonic discovery protocol.

5. The computing system according to claim 1, wherein the primary display device includes a speaker and a microphone array.

6. The computing system according to claim 1, wherein the microphone array of the second device is a stereoscopic microphone array.

7. The computing system according to claim 1, wherein the second signal is transmitted electrically or acoustically.

8. The computing system according to claim 1, wherein the primary display device is a master display device including the processor; and
the secondary display device is a slave device.

9. The computing system according to claim 1, wherein the system further comprises:
a third display device configured to transmit a third signal, and a fourth display device configured to transmit a fourth signal.

10. The computing system according to claim 1, wherein the positional relationship of the primary and secondary display devices is defined by a grid template.

11. The computing system according to claim 8, wherein the ultrasonic discovery protocol is configured to identify a display device in closest proximity to the primary display device as the secondary display device.

12. The computing system according to claim 1, wherein the primary display device is connected to the secondary display device via a wired connection.

13. The computing system according to claim 1, wherein a display mode for displaying the visual data is defined on a basis of the positional relationship of the primary and secondary display devices.

14. The computing system according to claim 1, wherein the processor is configured to transmit the positional relationship of display devices in the plurality of display devices to each display device.

15. The computing system according to claim 1, wherein the first signal is set to a frequency and emitted at an amplitude that is ineffective for transmitting the first signal through building walls.

16. A method for displaying visual data over a plurality of display devices, the method comprising:
configuring a processor to execute an ultrasonic discovery protocol;
operatively coupling a primary display device to the processor, the primary display device being configured to transmit a first signal;
operatively coupling a secondary display device to the processor, the secondary display device being configured to transmit a second signal;
detecting a positional trigger event;
executing the ultrasonic discovery protocol;
transmitting, by the primary display device, the first signal, the first signal being an acoustic signal;
receiving, by a microphone array of the secondary display device, the first signal;
in response to receiving the first signal, transmitting, by the secondary display device to the primary display device, the second signal, the second signal encoding data that indicates a positional relationship between the primary display device and the secondary display device; and
cooperatively displaying the visual data on the primary and secondary display devices based on the indicated positional relationship.

17. The method according to claim 16, the method further comprising:
defining a display mode for displaying the visual data based on the positional relationship of the primary and secondary display devices.

18. The method according to claim 16, the method further comprising:
defining the positional relationship of the primary and secondary display devices by a grid template.

19. The method according to claim 16, the method further comprising:
connecting the primary display device to the secondary display device via a wired connection such that the second signal can be transmitted electrically or acoustically.

20. A computing system capable of displaying visual data over a plurality of display devices, the computing system comprising:
a primary display device configured to transmit a first signal, the primary display device comprising a primary display and a processor configured to execute an ultrasonic discovery protocol; and
a secondary display device configured to transmit a second signal, the secondary display device comprising a secondary display;
the ultrasonic discovery protocol is programmatically executed upon detection of a positional trigger event;
execution of the ultrasonic discovery protocol by the processor causes the primary display device to transmit the first signal, the first signal being an acoustic signal received via a stereoscopic microphone array of the secondary display device;
in response to receiving the first signal, the secondary display device transmits the second signal to the primary display device, the second signal being an electric signal that encodes data indicating a positional relationship between the primary display device and the secondary display device;
the primary and secondary display devices are configured to cooperatively display the visual data based on the indicated positional relationship; and
the positional relationship of the primary and secondary display devices is defined by a grid template and determines a display mode for displaying the visual data.
